(19) United States
(12) Patent Application Publication
(10) Pub. No.: US 2013/0103523 A1
(43) Pub. Date: Apr. 25, 2013

(54) TRANSACTION STORAGE SCHEME FOR OFFLINE PAYMENT SYSTEM

(71) Applicants: Aneto Pablo Okonkwo, Zurich (CH); Patrick Pui Wah Leung, Paris (FR); Malgorzata Lisowiec, Dubendorf (CH); Fan Jiang, Adliswil (CH); Michael William Springer, Zurich (CH)

(72) Inventors: Aneto Pablo Okonkwo, Zurich (CH); Patrick Pui Wah Leung, Paris (FR); Malgorzata Lisowiec, Dubendorf (CH); Fan Jiang, Adliswil (CH); Michael William Springer, Zurich (CH)

(21) Appl. No.: 13/280,209

(22) Filed: Oct. 24, 2011

(51) Int. Cl. G06Q 30/06; G06K 19/07

(52) U.S. Cl. 705/26.1; 235/492

(57) ABSTRACT

Offline processing and storage of purchases is possible with the tap of a smart card to a contactless device. The smart card transmits its transaction history to the contactless device. The user may deposit funds onto the smart card, wherein the merchant enters the deposit information onto the contactless device and transmits a request to the remote system. The remote system processes the request and transmits a deposit record to the contactless device, which in turn transmits the deposit record to the smart card. The user also may withdraw funds from the smart card, wherein the contactless device determines whether the smart card has a sufficient balance available, by reading the current sum of deposits and the current sum of withdrawals from the smart card. The sum of withdrawals is current on the smart card even if the contactless device does not have network access to the remote system.

### TECHNICAL FIELD

The present disclosure relates generally to near field communication (NFC) enabled smart cards and, more particularly, to methods and systems for offline processing of purchases using NFC smart cards.

### BACKGROUND

Near Field Communication (NFC) is a proximity communication technology that can enable contactless device payment technologies and that is supported by the Global System for Mobile Communications (GSM) Association. Radio frequency identification (RFID) is another wireless communication technology that can be adapted to enable NFC smart card payment technology. NFC communication generally is conducted in a range from about 3 to about 4 inches. Such short communication distances enable secure communication between close field proximity enabled devices. In operation of an NFC transaction, a user “taps” a device, such as an NFC-enabled mobile phone or NFC-enable smart card, to a reader. The reader recognizes the NFC-enabled device when the device is moved within range of the reader, establishes a secure communication channel with the device, and initiates a payment transaction between the reader and the device.

Smart cards are devices with an embedded integrated circuit (for example, a microprocessor and/or memory) for use as storage of data. Smart cards typically are credit card sized electronic devices that have a variety of uses and can be utilized in any transaction that involves the exchange of data or information. Smart card technology has been particularly useful in financial transaction systems. Smart cards generally do not include a data entry device for direct entry of data. Instead, a smart card is used in conjunction with a card reader and/or an input device. Traditionally, a smart card is linked to a financial account or contains financial account information. Consequently, when the smart card is used, the reader receives the financial account information and conducts a debit transaction from the financial account, requiring network access to process the on-line transaction. Such conventional smart cards are inoperable when access to a network or to specific computers on the network is not available.

### SUMMARY

In certain exemplary aspects, a method of allowing offline processing of purchases can include a contactless device that facilitates automatic, convenient, and secure communications with a smart card. The user taps the smart card in the contactless device's radio frequency field. The contactless device and the smart card establish a secure communication channel. Once a secure communication channel is established, the smart card transmits its transaction history to the contactless device. The contactless device reads the current sum of deposits and the current sum of withdrawals and calculates the smart card balance by subtracting the sum of withdrawals from the sum of deposits. The user may withdrawal funds from the smart card if the balance is a number greater than or equal to the current transaction cost. If sufficient balance is available, the contactless device processes a debit transaction to debit the current transaction cost from the current sum of withdrawals. The contactless device transmits a withdrawal record to the smart card indicating the transaction cost debited from the smart card and the new sum of withdrawals. The contactless device stores the smart card transaction history until it has network access. At that time, it transmits the transaction history to the remote system.

These and other aspects, objects, features, and advantages of the exemplary embodiments will become apparent to those having ordinary skill in the art upon consideration of the following detailed description of illustrated exemplary embodiments, which include the best mode of carrying out the invention as presently perceived.

### BRIEF DESCRIPTION OF THE DRAWINGS

FIG. 1 is a block diagram depicting a system for processing an offline purchase initiated by a tap of a smart card with a contactless device and/or card reader according to an exemplary embodiment.

FIG. 2 is a block flow diagram depicting a method for processing a deposit of funds to a smart card via a contactless device according to an exemplary embodiment.

FIG. 3 is a block flow diagram depicting a method for depositing funds to a smart card via a contactless device according to an exemplary embodiment.

FIG. 4a is a block flow diagram depicting a method for creating a remote system user account for association with a smart card account according to an exemplary embodiment.

FIG. 4b is a block flow diagram depicting a method for activating a new smart card without associating the smart card with a remote system user account according to an exemplary embodiment.

FIG. 5 is a block flow diagram depicting a method for processing a withdrawal of funds from a smart card via a contactless device according to an exemplary embodiment.

FIG. 6 is a block flow diagram depicting a method for determining a balance of funds on a smart card according to an exemplary embodiment.

FIG. 7 is a block flow diagram depicting a method for synchronizing smart card transactions on a remote system according to an exemplary embodiment.

### DETAILED DESCRIPTION OF EXEMPLARY EMBODIMENTS

### Overview

The exemplary embodiments provide methods and systems that enable users to utilize offline processing of purchases with a smart card and a card reader. The user taps the smart card in the radio frequency field of the contactless device, such as a card reader. The contactless device and the smart card establish a secure communication channel. Once a secure communication channel is established, the smart card transmits its transaction history to the contactless device. If network access is available, the contactless device transmits this transaction history to a remote system that analyzes the transactions. If the smart card is new, the contactless device may create an account and/or register the card.

The user may deposit funds onto the smart card using the contactless device. A merchant operating the contactless device enters deposit information onto the contactless device, based on funds provided by a user of the smart card to the merchant. The contactless device transmits a request to the remote system. The remote system processes the request and calculates a new sum of deposits. The remote system then transmits a deposit record to the contactless device. The contactless device transmits the deposit record to the smart card, and the secure communication channel is then terminated.

The user also may withdraw funds from the smart card using the contactless device. The merchant determines whether the smart card has a sufficient balance available for a purchase transaction by using the contactless device to read the current sum of deposits and the current sum of withdrawals from the smart card. The contactless device then calculates the balance by subtracting the sum of withdrawals from the sum of deposits. If the balance is a number greater than or equal to the current transaction cost, the transaction is authorized. If sufficient balance is available, the contactless device processes a debit transaction to debit the current transaction cost from the current sum of withdrawals. The contactless device transmits a withdrawal record to the smart card indicating the transaction cost debited from the smart card and the new sum of withdrawals. A withdrawal transaction may be performed without network access. In this instance, the contactless device stores the smart card transaction history until it has network access. At that time, the contactless device transmits the transaction history to the remote system.

One or more aspects of the invention may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as more than one computer may perform the act. The inventive functionality of the invention will be explained in more detail in the following description, read in conjunction with the figures illustrating the program flow.

### System Architecture

Turning now to the drawings, in which like numerals indicate like (but not necessarily identical) elements throughout the figures, exemplary embodiments are described in detail.

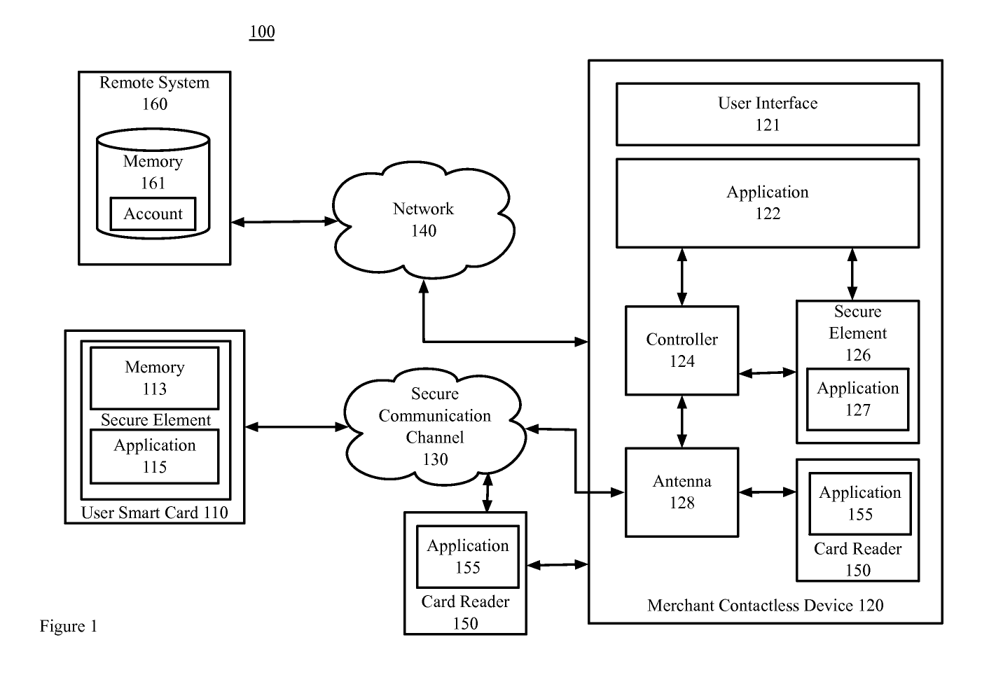

FIG. 1 is a block diagram depicting a system 100 for processing an offline purchase initiated by a tap of a smart card 110 with a contactless device 120, comprising a card reader 150, according to an exemplary embodiment. As depicted in FIG. 1, the exemplary operating environment 100 includes a merchant contactless device system 120 and a user smart card system 110 that are configured to communicate with one another via one or more secure communication channels 130. The exemplary operating environment 100 also includes a remote computer system 160 that is configured to communicate with the merchant contactless device system 120 via one or more networks 140.

In exemplary embodiments, the secure communication channel 130 can comprise communication via a close proximity communication protocol, such as near field communication (NFC), Bluetooth, or Wi-Fi, using appropriate protocols corresponding to those communication methods. In an alternative exemplary embodiment, the secure communication channel 130 can comprise a cellular network.

In an exemplary embodiment, NFC communication protocols include, but are not limited to ISO/IEC 14443 type A and/or B technology (hereafter “ISO 14443”), MIFARE technology (hereafter “MIFARE”), and/or ISO/IEC 18092 technology (hereafter “ISO 18092”). ISO 14443 is a communication protocol for contactless devices operating in close proximity with a reader. An ISO 14443 communication protocol is utilized for secure card payments, including but not limited to credit card payments, debit card payments, and other forms of financial card payments. MIFARE is a communication protocol for contactless devices that comply with proprietary device standards that are based on ISO 14443. A MIFARE protocol is utilized for stored function transactions, including but not limited to gift cards, transit cards, tickets, access cards, loyalty cards, and other forms of stored value card transactions. A MIFARE protocol may also be used for limited value-added services. ISO 18092 is a communication protocol for contactless devices operating at higher bit rates, allowing for richer communication between the devices. An ISO 18092 communication protocol is utilized for peer-to-peer communication, value-added services (including, but not limited to, coupons, loyalty cards, check-ins, membership cards, gift cards, and other forms of value-added services), and other forms of richer communication. Any suitable NFC communication protocol can be used for NFC communication between the smart card 110 and the contactless device 120 to implement the methods and functionality described herein.

In an exemplary embodiment, the contactless device system 120 can refer to a smart device that can communicate via an electronic, magnetic, or radio frequency field between the device 120 and another device, such as a smart card 110. In an exemplary embodiment, the contactless device 120 has processing capabilities, such as storage capacity/memory and one or more applications 122 that can perform a particular function. In an exemplary embodiment, the contactless device 120 contains an operating system (not illustrated) and user interface 121. Exemplary contactless devices 120 include smart phones; mobile phones; personal digital assistants (PDAs); mobile computing devices, such as netbooks, tablets, and iPads; laptops; and other devices, in each case having processing and user interface functionality.

The contactless device 120 also comprises a secure element, which can exist within a removable smart chip or a secure digital (SD) card or which can be embedded within a fixed chip on the device 120. In certain exemplary embodiments, Subscribed Identity Module (SIM) cards may be capable of hosting a secure element 126, for example, an NFC SIM Card. The secure element 126 allows a software application 122 resident on the device 120 and accessible by the device user to interact securely with certain functions within the secure element 126, while protecting information stored within the secure element. The secure element 126 comprises applications 127 running thereon that perform the functionality described herein.

The secure element 126 includes components typical of a smart card, such as crypto processors and random generators. In an exemplary embodiment, the secure element 126 comprises a Smart MX type NFC controller 124 in a highly secure system on a chip controlled by a smart card operating system, such as a JavaCard Open Platform (JCOP) operating system. In another exemplary embodiment, the secure element 126 is configured to include a non-EMV type contactless smart card, as an optional implementation.

The secure element 126 communicates with the controller 124 and the application 122 in the contactless device 120. In an exemplary embodiment, the secure element 126 is capable of storing encrypted user information and only allowing trusted applications to access the stored information. The controller 124 interacts with a secure key encrypted application 122 for decryption and installation in the secure element 126.

In an exemplary embodiment, the controller 124 is a Bluetooth link controller. The Bluetooth link controller may be capable of sending and receiving data, identifying the smart card 110, performing authentication and ciphering functions, and directing how the contactless device 120 will listen for transmissions from the smart card 110 or configure the contactless device 120 into various power-save modes according to the Bluetooth-specified procedures. In another exemplary embodiment, the controller 124 is a Wi-Fi controller or an NFC controller capable of performing similar functions.

The application 122 is a program, function, routine, applet or similar entity that exists on and performs its operations on a contactless device 120. For example, the application 122 may be one or more of an offline payment application, a digital wallet application, a coupon application, a loyalty card application, another value-added application, a user interface application, or other suitable application operating on the contactless device 120. Additionally, the secure element 126 also may comprise secure contactless software applications, such as an offline payment or other payment applications, secure forms of the applications 122, authentication applications, payment provisioning applications, or other suitable application using the secure functionality of the secure element.

The contactless device 120 communicates with the smart card 110 via an antenna 128. In an exemplary embodiment, once the contactless device application 122 has been activated and prioritized, the controller 124 is notified of the state of readiness of the contactless device 120 for a transaction. The controller 124 outputs through the antenna 128 a radio signal, or listens for radio signals from the smart card 110. On establishing a secure communication channel between the contactless device 120 and the smart card 110, the contactless device 120 may request a list of applications 115 available from the smart card 110. A directory is first displayed, after which, based on the set priority or the type of smart card 110, an application 115 and 122 are chosen and initiated for the transaction.

An exemplary smart card 110 can refer to a smart device that can communicate via an electronic, magnetic or radio frequency field between the card 110 and another device, such as a contactless device 120 or a card reader 150. In an exemplary embodiment, the smart card 110 has processing capabilities, such as storage capacity/memory 113 and one or more applications 115 that can perform a particular function. In an exemplary embodiment, the smart card also has an NFC enabled chip (not illustrated) implemented, either independently or on existing components, within the smart card 110. Exemplary smart cards 110 may include MIFARE cards, stored value memory cards, and other types of memory cards.

In an exemplary embodiment, the memory 113 and application 115 may be implemented in a secure element, as described previously, on the smart card 110. The smart card 110 also may contain one or more secrete keys that control access to the information contained in the memory 113. For example, security measures can include password keys and logic that are hard-coded into the smart card 110 by the manufacturer.

As depicted in FIG. 1, the card reader 150 may be a component of the contactless device 120. For example, in an exemplary embodiment, the card reader 150 is a contactless device application 122, wherein information exchanged with the smart card 110 via the secure communication channel 130 and antenna 128 is processed via the application 122.

In an alternative exemplary embodiment, the card reader 150 may be a separate standalone device that communicates with the smart card 110 via one or more secure communication channels 130 and with the contactless device 120. As a standalone device, the card reader 150 can refer to a device that can communicate via an electronic, magnetic, or radio frequency field between the card reader 150 and another device, such as the smart card 110 and/or the contactless device 120. In this embodiment, the card reader 150 passes information between the smart card 110 and the contactless device 120. Additionally, when implementing this embodiment, the contactless device 120 may be a computer that does not have contactless NFC functionality, such as a desktop computer, server computer, laptop computer, mobile computing device (such as a mobile telephone, tablet computer, or smart phone), or other non-NFC enabled device.

In an exemplary embodiment, the card reader 150 has processing capabilities, such as storage capacity/memory and one or more applications 155 that can perform a particular function. In an exemplary embodiment, the card reader 150 contains an operating system (not illustrated) and user interface (not illustrated).

The card reader 150 is communicatively coupled to the contactless device 120 via a direct connection, via one or more secure communication channels 130, or via a network 140 (connection not illustrated).

As further depicted in FIG. 1, the contactless device 120 may be communicatively coupled to the remote system 160 via a network 140. In an alternative exemplary embodiment, the card reader 150 is also communicatively coupled to the remote system 160 via a network 140. The network 140 comprises a telecommunication means by which network devices (including devices 120, 150, and 160) can exchange data. For example, the network 140 can be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet, Bluetooth, NFC or any other appropriate architecture or system that facilitates the communication of signals, data and/or messages (generally referred to as data).

According to an exemplary embodiment, the contactless device 120 may connect to network 140 via a wired connection. For example, the connection may be a wired universal serial bus (USB) or Ethernet connection. In an alternative exemplary embodiment, the contactless device 120 may connect to the network via a wireless connection. For example, the connection may be a Wi-Fi or Bluetooth connection to a hotspot that has a wired/wireless Internet connection (for example, MiFi), or any other wired or wireless connection suitable for communicating signals with network 140. In an alternative exemplary embodiment, the connection may be a cellular network connection.

The exemplary remote system 160 enables storage of smart card 110 account information. In an exemplary embodiment, the user (not illustrated) creates a user account with the remote system 160 and registers a smart card 110. The remote system stores the smart card 110 data, including a history of all the card transactions, for example, each deposit of funds and each withdrawal of funds. In an exemplary embodiment, the remote system 160 analyzes the transaction history to identify missing data or possible errors.

Throughout this specification, it should be understood that the terms “data” and “information” are used interchangeably herein to refer to text, images, audio, video, or any other form of information that can exist in a computer-based environment.

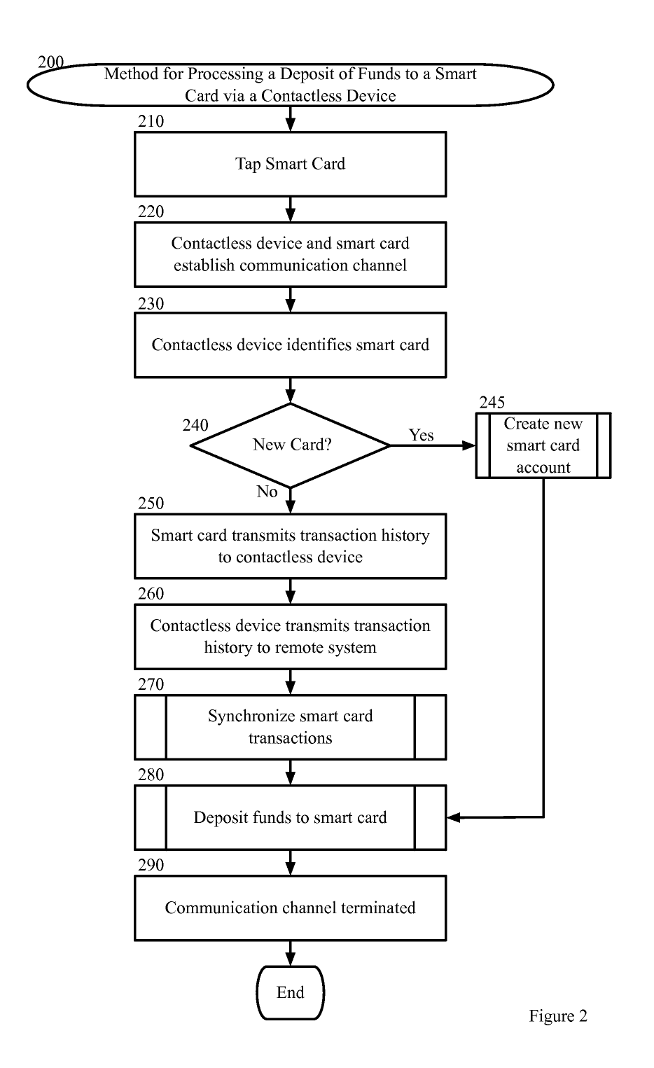

The components illustrated in FIG. 1 will be described in further detail hereinafter with reference to the methods depicted in FIGS. 2-7.

### System Process

FIG. 2 is a block flow diagram depicting a method for processing a deposit of funds to a smart card 110 via a contactless device 120 according to an exemplary embodiment. The method 200 is described with reference to the components illustrated in FIG. 1.

In an exemplary embodiment, a deposit transaction must be authorized by the remote system 160. The contactless device 120 has network 140 access, to provide such authorization.

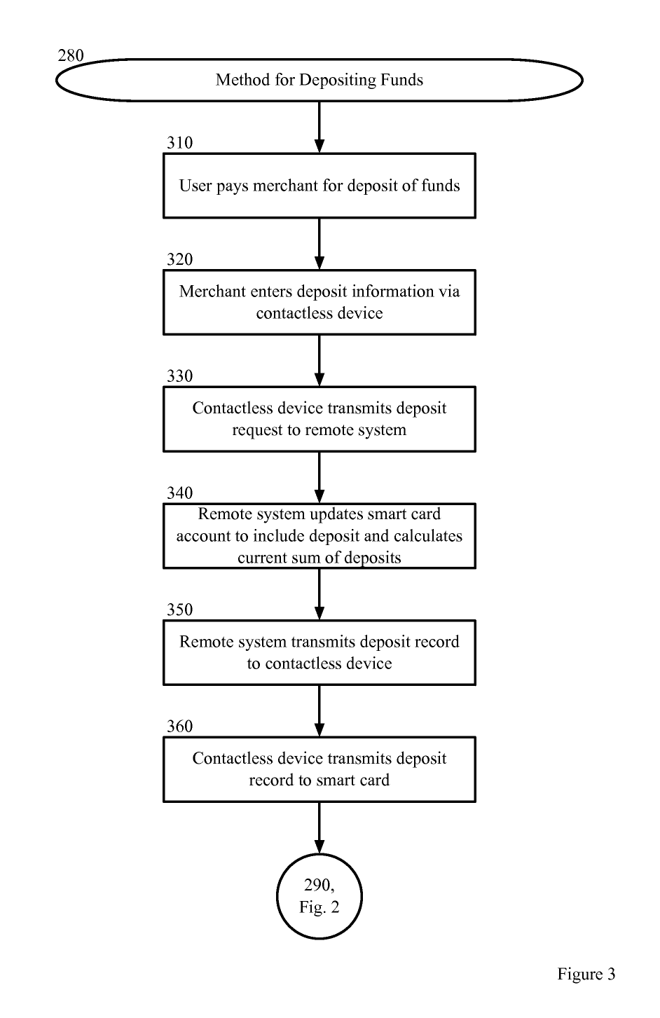

In block 210, the user “taps” the smart card 110 in the proximity of the contactless device 120. In an exemplary embodiment, the contactless device 120 generates a radio frequency (RF) or other field polling for the presence of a smart card 110, and the user “taps” the smart card 110 by placing the card 110 within the field of the contactless device 120. In an alternative exemplary embodiment, the merchant activates the RF field or other field to poll for the presence of a smart card 110 using an application 122 on the contactless device 120. In certain exemplary embodiments, the systems and methods described in FIGS. 2-3 herein are performed while the smart card 110 is tapped.

The contactless device 120 detects the smart card 110 and establishes a secure communication channel 130 in block 220. In an exemplary embodiment, the secure communication channel 130 is an NFC communication channel.

In block 230, the contactless device 120 identifies the smart card 110. In an exemplary embodiment, the contactless device 120 requests protocols and characteristics from the smart card. For example, the contactless device may request the identification of communication protocols (for instance ISO/IEC 14443, MIFARE, and/or ISO/IEC 18092), a list of applications 115 available, card identification information (for instance card number), and security protocols from the smart card 110. In an exemplary embodiment, the contactless device reads the information from the smart card 110 or the smart card 110 otherwise responds with the requested information.

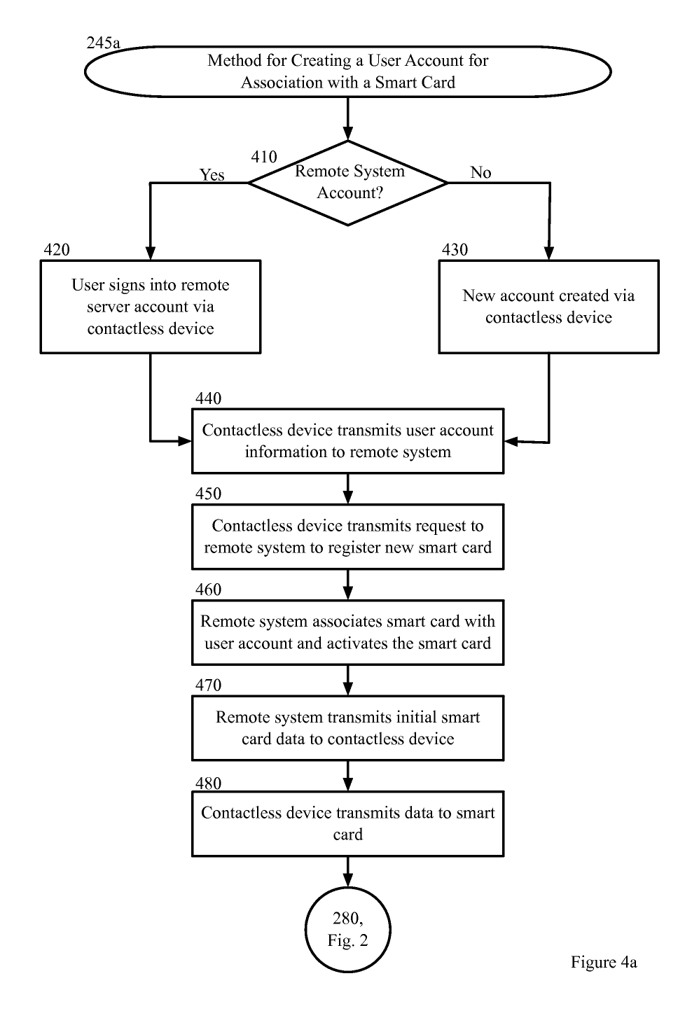

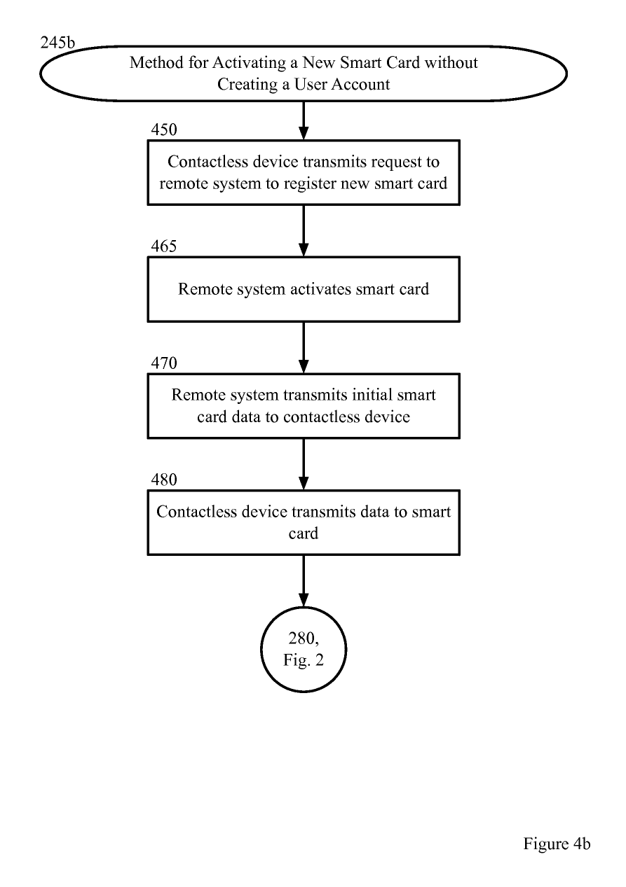

The contactless device 120 determines whether the smart card 110 is a new or existing card, in block 240. For example, the contactless device 120 may communicate information from the smart card 110 to the remote system 160, which maintains a database of all smart cards. The remote system 160 may respond with information regarding the smart card 110, such as whether the smart card 110 is an existing card registered with the remote system 160 or the smart card 110 is a new card that has not been registered to a user. If the smart card 110 is new, the new card is activated and/or a new account is created at block 245. The method for creating a new smart card account is described in more detail hereinafter with reference to the methods described in FIGS. 4a and 4b.

If the smart card 110 is not new but is already registered with the remote system 160, the smart card 110 transmits the entire saved transaction history from its memory 113 to the contactless device 120, in block 250. In an exemplary embodiment, the smart card 110 transmits all deposit and withdrawal transactions to the contactless device 120. If the amount of the transactions exceeds the storage/memory 113 capabilities of the smart card 110, the oldest transactions are dropped from the smart card memory 113. In an exemplary embodiment, the smart card 110 alternatively or additionally transmits the sum of deposits and the sum of withdrawals for all previous transactions to the contactless device 120.

In block 260, the contactless device 120 transmits the smart card 110 transaction history to the remote system 160. In an exemplary embodiment, the deposit transaction occurs when the contactless device 120 has network 140 access, allowing for simultaneous transmission of the smart card 110 transaction history to the remote system 160. In an alternative embodiment, the smart card 110 transaction history is stored on the contactless device 120 and transmitted to the remote system 160 at a later time after the completion of the deposit of funds via a wireless or wired network connection 140.

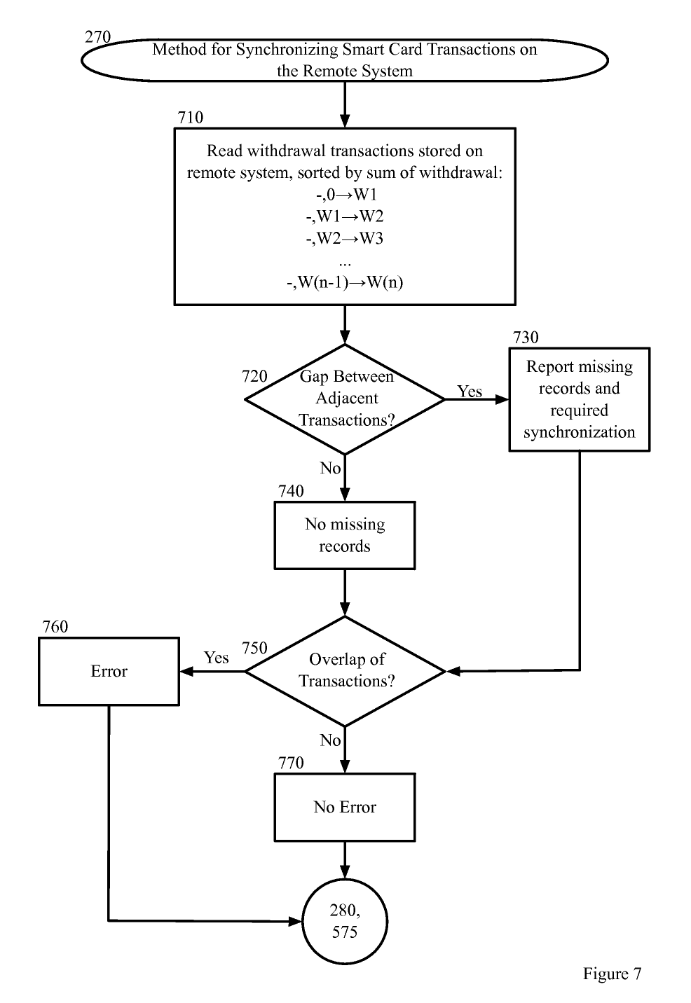

After the smart card 110 transactions are transmitted to the remote system 160, the remote system 160 analyzes and synchronizes the transactions, in block 270. In an exemplary embodiment, block 270 occurs immediately after the transmission of the transactions to the remote system 160. In an alternative exemplary embodiment, block 270 occurs at a later time or at a set durational time period (for example, every 24 hours). The method 270 of synchronizing smart card 110 transactions on the remote system 160 is described in more detail hereinafter with reference to the methods described in FIG. 7.

In block 280, the contactless device 120 deposits funds onto the smart card 110. The method of depositing funds is described in more detail hereinafter with reference to the methods described in FIG. 3.

The method 200 then proceeds to block 290 in which the secure communication channel 130 between the smart card 110 and the contactless device 120 is terminated.

FIG. 3 is a block flow diagram depicting a method for depositing funds to a smart card 110 via a contactless device 120 according to an exemplary embodiment, as referenced in block 280 of FIG. 2. The method 280 is described with reference to the components illustrated in FIG. 1.

In block 310, the user pays the merchant for the deposit of funds. In an exemplary embodiment, the payment is a cash payment. In an alternative exemplary embodiment, the payment is a credit card payment or other electronic payment. In this embodiment, payment may be made using a contactless tap of the credit card to the contactless device or by swiping the credit card or other card with a credit card reader.

The merchant enters the deposit information into the contactless device 120, in block 320. In an exemplary embodiment, the merchant enters the deposit information with the user interface 121 of the contactless device. In an exemplary embodiment, a pop-up window appears after the smart card 110 transaction history is transmitted to the remote system 160. In an alternative exemplary embodiment, the merchant accesses an application 122 to enter the deposit information.

In block 330, the contactless device transmits a deposit request to the remote system 160 via a network 140. In an exemplary embodiment, the deposit request includes the deposit amount, smart card 110 identification information, a timestamp, and the merchant identification.

The remote system 160 updates an account associated with the smart card 110 to include the deposit of funds and calculates a new sum of deposits for the smart card 110, in block 340. In this regard and as described herein with reference to the records of the smart card 110 maintained by the remote system 160, the remote system 160 can maintain an account for each smart card 110. Each account for a particular smart card 110 can comprise one or more of information maintained on the smart card 110, user registration information, transaction history, and other information for maintaining the smart card 110. The remote system 160 can store each account record in the database 161.

In block 350, the remote system 160 transmits a deposit record to the contactless device 120. The contactless device 120 then transmits the deposit record to the smart card 110, in block 360. In an exemplary embodiment, the deposit record includes the new sum of deposits, the card identification, a time stamp and a merchant identification.

From block 360, the method 280 proceeds to block 290 (FIG. 2).

In an alternative embodiment, the user may deposit funds to the remote system 160 using a computer (not illustrated) and network 140. In this embodiment, the user makes a payment of funds to the remote system 160, and the remote system 160 associates the funds with the account corresponding to the particular smart card 110 in the possession of the user, based on identification information of the smart card 110. The user can deposit funds to the remote system 160 using any electronic payment method accepted by the remote system 160 and available to the user via the computer operated by the user. The funds are not stored on the smart card 110 until the user taps the smart card 110 with a contactless device 120, where the contactless device 120 has communication access with the remote system 160 via the network 140. Blocks 310-340 may be omitted from the method 280, and the funds may be deposited on the smart card 110 by following blocks 350-360 upon identification of the smart card 110 to the remote system 160 by the contactless device 120. For example, after the transaction history is communicated to the remote system 160 at block 260, the remote system 160 transmits a deposit record to the contactless device 120 at block 350.

FIG. 4a is a block flow diagram depicting a method 245a for creating a remote system 160 user account for association with a smart card 110 according to an exemplary embodiment, as referenced in block 245 of FIG. 2. The method 245a is described with reference to the components illustrated in FIG. 1.

Referring back to FIG. 2, the contactless device 120 detects the smart card 110 and establishes a secure communication channel 130 in block 220, and the contactless device 120 identifies the smart card 110, in block 230. The contactless device 120 then determines whether the smart card 110 is a new or existing card, in block 240.

If the card 110 is new, a new account is created at block 245. In an exemplary embodiment, the user creates a new user account or logs into an existing account via the remote system 160, with which the smart card 110 will be associated. The method 245a depicted in FIG. 4a describes associating a new smart card with a new or existing user account at the remote system 160.

In an alternative exemplary embodiment, the user activates a new smart card 110 without creating or logging into a remote system 160 account. In this case, only a smart card account is created at the remote system 160. The method for activating a new smart card 110 without a user account is described in more detail hereinafter with reference to the methods described in FIG. 4b.

Referring to FIG. 4a, in block 410, the contactless device 120 determines whether the user has a remote system 160 account.

If the user has a remote system 160 account, the user signs into the account via the contactless device 120, in block 420. In an exemplary embodiment, the user utilizes the user interface 121 of the contactless device 120 to communicate with the remote system 160 to access the user's account. For example, the user may input a personal identification number or other identifying and/or authentication information to identify and access the user's account at the remote system 160.

If the user does not have a remote system 160 account, the user may create a new account via the contactless device 120, in block 430. In an exemplary embodiment, the user utilizes the user interface 121 of the contactless device 120 to communicate with the remote system 160 to create an account. The user may be prompted to enter identifying information, for example, user name, phone number, e-mail address, personal identification number or other password, or other suitable information to create the user account.

In block 440, the contactless device 120 transmits the user account information to the remote system 160. Portions or all of block 440 may occur simultaneously with performance of blocks 420 or 430. In an exemplary embodiment, the contactless device 120 has network 140 access and transmits the user account information using a wireless connection. In an alternative exemplary embodiment, the contactless device 120 is connectively coupled via a wired connection to a computer that accesses the remote system 160.

In block 450, the contactless device 120 transmits a request to the remote system 160 to register a new smart card 110 with the user's account. In an exemplary embodiment, the request includes information to identify the card, such as a card number or other identifying information stored on the smart card 110. The request also may include the date the card was registered (for example, a time stamp), where the card was registered (for example, information identifying the merchant that registered the card), user information, or other suitable information.

The remote system 160 associates the smart card 110 with the user's account and activates the smart card 110, in block 460. In an exemplary embodiment, the remote system 160 notes the information included in the request in the user account to allow the user to view the smart card 110 transaction history, sum of withdrawals, and sum of deposits by logging onto the user's remote system 160 account.

In block 470, the remote system 160 transmits the initial smart card 110 data to the contactless device 120. In an exemplary embodiment, the initial data comprises activation data for the smart card 110, which allows the smart card 110 to be used for purchase and/or deposit transactions.

The contactless device 120 transmits the activation data to the smart card 110, in block 480, and the activation data is stored in the memory 113 of the smart card 110.

From block 480, the method 245a proceeds to block 280 (FIG. 2) and funds are deposited onto the smart card 110.

FIG. 4b is a block flow diagram depicting a method 245b for activating a new smart card 110 without associating the smart card 110 with a remote system 160 user account according to an exemplary embodiment, as referenced in block 245 of FIG. 2. The method 245b is described with reference to the components illustrated in FIG. 1.

Blocks 450, 470, and 480 depicted in FIG. 4b are similar to blocks 450, 470, and 480 depicted in FIG. 4a.

Referring back to FIG. 2, the contactless device 120 detects the smart card 110 and establishes a secure communication channel 130 in block 220, and the contactless device 120 identifies the smart card 110, in block 230. The contactless device 120 then determines whether the smart card 110 is a new or existing card, in block 240. In an exemplary embodiment, the user activates a new smart card 110 without creating or logging into a remote system 160 account.

In block 450, the contactless device 120 transmits a request to the remote system 160 to register a new smart card 110.

The remote system 160 activates the smart card 110, in block 460. In an exemplary embodiment, the remote system 160 assigns a personal identification number (PIN) or other authentication code to the smart card 110.

In block 470, the remote system 160 transmits the initial smart card 110 data to the contactless device 120. In an exemplary embodiment, the initial data includes the activation data for the smart card 110 and may include the assigned PIN.

The contactless device 120 transmits the activation data to the smart card, in block 480, which stores the activation data in the memory 113.

From block 480, the method 245b proceeds to block 280 (FIG. 2) and funds are deposited onto the smart card 110.

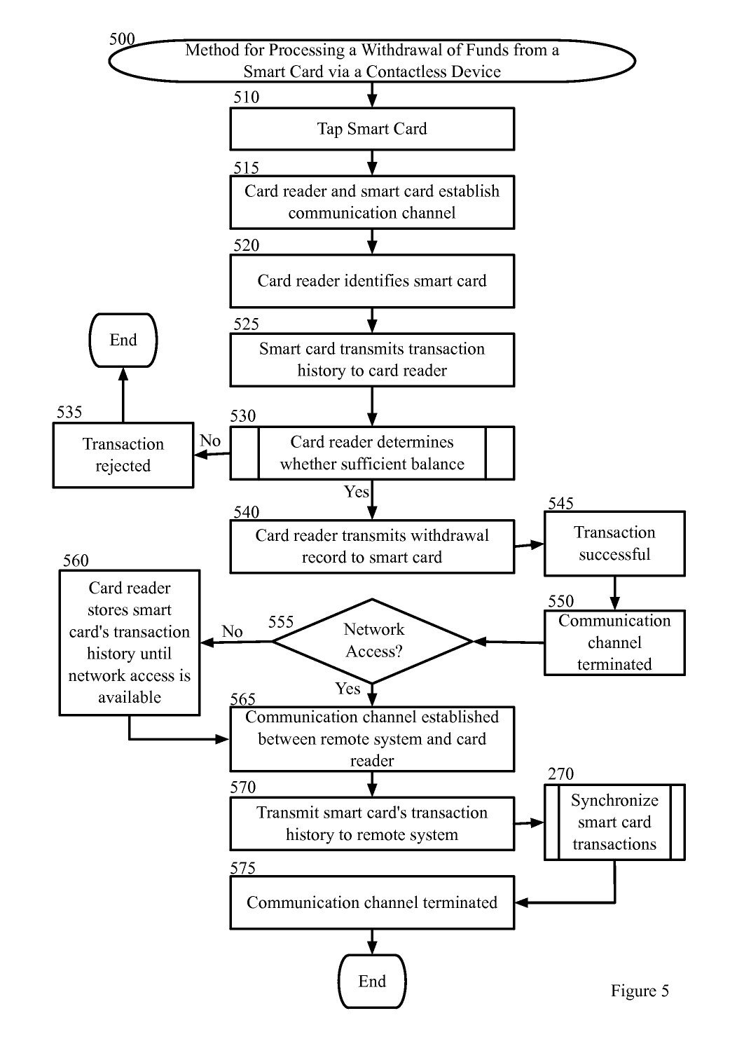

FIG. 5 is a block flow diagram depicting a method 500 for processing a withdrawal of funds from a smart card 110 via a contactless device 120 according to an exemplary embodiment. The method 500 is described with reference to the components illustrated in FIG. 1.

In an exemplary embodiment, a withdrawal transaction does not require remote system 160 authorization. The contactless device 120 may or may not have network 140 access at the time of the transaction.

In block 510, the user “taps” the smart card 110 in the proximity of the contactless device 120. In an exemplary embodiment, the card reader 150 that reads information from the smart card 110 is a part of the contactless device 120. In an alternative exemplary embodiment, the card reader 150 is a separate stand-alone device in communication with a computer, such as the contactless device 120.

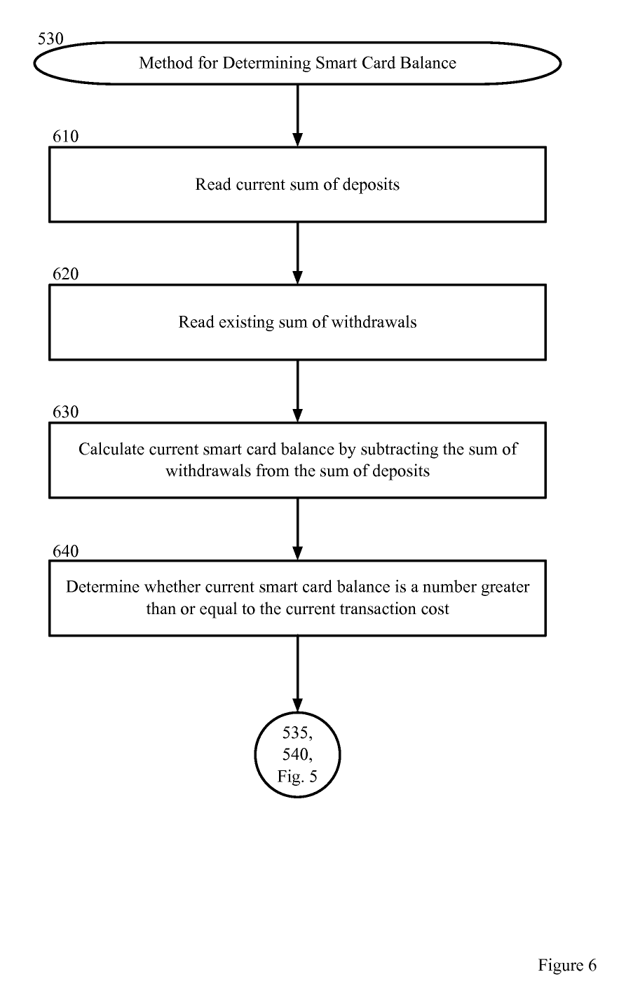

In an exemplary embodiment, the contactless device 120 generates a radio frequency (RF) or other field polling for the presence of a smart card 110, and the user “taps” the smart card 110 by placing the card 110 within the field of the contactless device 120. In an alternative exemplary embodiment, the merchant activates the RF field or other field to poll for the presence of a smart card 110 using an application 150 on the card reader 150. In certain exemplary embodiments, the systems and methods described in FIGS. 5-6 herein are performed while the smart card 110 is tapped.

The contactless device 120 detects the smart card 110 and establishes a secure communication channel 130 in block 515. In an exemplary embodiment, the secure communication channel 130 is an NFC communication channel.

In block 520, the contactless device 120 identifies the smart card 110. In an exemplary embodiment, the contactless device 120 requests protocols and characteristics from the smart card. For example, the contactless device may request the identification of communication protocols (for instance, ISO 14443, MIFARE, and/or ISO 18092), a list of available applications 115, card identification information (for instance, card number), and security protocols from the smart card 110. In an exemplary embodiment, the smart card 110 responds with the information requested.

The smart card 110 transmits the entire saved transaction history from its memory 113 to the contactless device 120, in block 525. In an exemplary embodiment, the smart card 110 transmits all deposit and withdrawal transactions to the contactless device 120. If the amount of the transactions exceeds the storage/memory 113 capabilities of the smart card 110, the oldest transactions are dropped from the smart card memory 113. In an exemplary embodiment, the smart card 110 alternatively or additionally transmits the sum of deposits and the sum of withdrawals for all previous transactions to the contactless device 120. In an alternative exemplary embodiment, the smart card 110 transmits the last deposit transaction and the entire saved withdrawal transaction history from its memory 113 to the contactless device 120. If the amount of withdrawals exceeds the storage/memory 113 capability of the smart card 110, the oldest transactions are dropped from the smart card memory 113. In an exemplary embodiment, the transmission of the withdrawal history includes the last several withdrawal transactions to ensure if a particular contactless device 120 doesn't come back online its transactions still get transmitted to the remote system 160.

In block 530, the contactless device 120 determines whether the smart card 110 has a sufficient balance for the transactions. The method of determining the balance of funds on a smart card 110 is described in more detail hereinafter with reference to the methods described in FIG. 6.

FIG. 6 is a block flow diagram depicting a method 530 for determining a balance of funds on a smart card 110 according to an exemplary embodiment. The method 530 is described with reference to the components illustrated in FIG. 1.

In an exemplary embodiment, it may be difficult to determine the smart card 110 balance using the remote system 160 records, since a withdrawal may or may not occur when the contactless device 120 has network access to the remote system 160. Therefore, the sum of deposits and sum of withdrawals will be calculated and saved on the smart card 110 as at least a part of the transaction history stored on the smart card 110.

In block 610, the contactless device 120 reads the current sum of deposits from the transaction history of the smart card 110. In an exemplary embodiment, the contactless device 120 contains the entire transaction history transmitted from the smart card 110, at block 525, including the current sum of deposits. The contactless device 120 reviews the current sum of deposits entry. In an alternative exemplary embodiment, if the sum of deposits was not transmitted at block 525, the contactless device 120 uses the transaction history showing all deposits on the smart card 110 to calculate the sum of deposits.

In block 620, the contactless device 120 reads the current sum of withdrawals from the transaction history of the smart card 110. In an exemplary embodiment, the contactless device 120 contains the entire transaction history transmitted from the smart card 110, at block 525, including the current sum of withdrawals. The contactless device 120 reviews the current sum of withdrawals entry. In an alternative exemplary embodiment, if the sum of withdrawals was not transmitted at block 525, the contactless device 120 uses the transaction history showing all deposits on the smart card 110 to calculate the sum of withdrawals.

In an exemplary embodiment, the remote system 160 will have the current sum of deposits, since these transactions are completed while the contactless device 120 has network 140 access to the remote system 160. The remote system 160 may not have the current sum of withdrawals, since the contactless device 120 may or may not have network 140 access to the remote system 160 at the time of the transaction, but the remote system 160 will have the sum of withdrawals at the time of the last synchronization. The contactless device 120 reads the current sum of withdrawals by reading the last withdrawal transaction from the smart card 110 and the current sum of deposits by reading the last deposit transaction from the smart card 110.

In an exemplary embodiment, a deposit transaction is recorded as:

D1: sum of deposits before this transaction

D2: sum of deposits after this transaction

Notation: +,D1→D2

In an exemplary embodiment, a withdrawal transaction is recorded as:

W1: sum of withdrawals before this transaction

W2: sum of withdrawals after this transaction

Notation: −,W1→W2

The contactless device 120 calculates the current smart card 110 balance, in block 630. In an exemplary embodiment, the balance is calculated by subtracting the sum of withdrawals from the sum of deposits. In an exemplary embodiment, the contactless device 120 can calculate the lower boundary of the card balance. For example:

Balance≧last known sum of deposits−last known sum of withdrawals

For example, using the following transaction history:

| | |
|---|---|
| A new card is created with zero balance | +, 0→0 |
| | −, 0→0 |
| Deposit 20 | +, 0→20 |
| Withdraw 4 | −, 0→4 |
| Withdraw 8 | −4→12 |
| Deposit 10 | +20→30 |
| Withdraw 7 | −, 12→19 |
| Withdraw 2 | −, 19→21 |

the current card balance can be calculated using the last deposit and withdrawal transactions:
+,20→30
−,19→21

Balance=30−21=9

In block 640, the contactless device 120 determines whether the smart card 110 balance is a number greater than or equal to the current transaction cost. In an exemplary embodiment, the smart card 110 balance may not be a negative number (in other words, the smart card 110 may not become overdrawn).

In an alternative exemplary embodiment, the smart card 110 calculates and stores a balance in the memory 113 after each transaction. In yet another exemplary embodiment, the smart card 110 stores a running list of all transactions and the balance is calculated by adding/subtracting each transaction as appropriate.

From block 640, the method 530 proceeds to block 540 or block 535 (FIG. 5).

Returning to FIG. 5, if the contactless device 120 determines in block 530 that the smart card 110 does not have a sufficient balance for the transaction, the transaction is rejected in block 535, and the secure communication channel 130 is terminated.

If the contactless device 120 determines in block 530 that the smart card 110 has a sufficient balance for the transaction, the contactless device 120 transmits a withdrawal record and new sum of withdrawals to the smart card 110. In an exemplary embodiment, the contactless device 120 writes a new transaction record to the smart card 110 illustrating the recent withdrawal transaction. The withdrawal transaction record comprises the transaction amount and a new sum of withdrawals as calculated by the contactless device 120. In an exemplary embodiment, the contactless device 120 creates a new withdrawal record and adds the record to the transaction history previously transmitted from the smart card 110 at block 525. In an exemplary embodiment, the withdrawal record also can comprise the smart card 110 identification, a time stamp, the merchant identification, the amount of the withdrawal, and other suitable information.

From block 540, the method 500 proceeds to block 545. In block 545, the contactless device 120 indicates that the transaction was successful, and the secure communication channel 130 is terminated, in block 550.

In block 560, the contactless device 120 determines whether it has network 140 access to the remote system 160. If the contactless device 120 does not have network 140 access, the contactless device 120 stores the smart card 110 transaction history (including the newly-added record) until network 140 access is available.

If the contactless device 120 has network 140 access, the contactless device 120 establishes a communication channel with the remote system 160, in block 565.

In block 570, the contactless device 120 transmits the smart card 110 transaction history to the remote system 160. In an exemplary embodiment, the withdrawal transaction occurs when the contactless device 120 has network 140 access, allowing for simultaneous transmission of the smart card 110 transaction history to the remote system 160. In an alternative embodiment, the smart card 110 transaction history is stored on the contactless device 120 and transmitted to the remote system 160 at a later time.

After the smart card 110 transactions are transmitted to the remote system 160, the remote system 160 analyzes and synchronizes the transactions, in block 270, which is similar to the block 270 referenced in FIG. 2. In an exemplary embodiment, this action occurs in real-time with (in other words, immediately after) the transmission of the transactions to the remote system 160. In an alternative exemplary embodiment, this action occurs at a later time or at a set durational time period (for example, once every 24 hours). The method 270 of synchronizing smart card 110 transactions on the remote system 160 is described in more detail hereinafter with reference to the methods described in FIG. 7.

In an exemplary embodiment, a transaction made by mistake, may be reverted by a merchant. The merchant sends the original transaction identification to the remote system 160 and requests reversion of the transaction. In an exemplary embodiment, the remote system 160 creates a new transaction for the same amount, but as an opposite type of transaction (for example, to revert a withdrawal, the transaction type would be a deposit). The original transaction is still maintained in the transaction history, but the smart card 110 balance is corrected the next time the smart card is connected to a contactless device 120 with network 140 access to the remote system 160.

In block 575, the secure communication channel is terminated, and the method 500 ends.

FIG. 7 is a block flow diagram depicting a method for synchronizing smart card 110 transactions on a remote system 160 according to an exemplary embodiment, as referenced in block 270 of FIGS. 2 and 5. The method 270 is described with reference to the components illustrated in FIG. 1.

The remote system 160 performs an analysis and synchronization of the smart card 110 transaction history received from the contactless device 120. In an exemplary embodiment, the remote system 160 performs the analysis when the transaction history is transmitted. In an alternative exemplary embodiment, the analysis is performed at set time intervals (for example, once every 24 hours). Because the deposit transactions are completed with network 140 access, an analysis of the deposit transactions is not required, as those deposit transactions are updated in the remote system 160 in real-time. In an alternative exemplary embodiment, an analysis of the withdrawal and deposit transactions is performed.

In block 710, the remote system 160 reads the withdrawal transactions, sorted by the sum of withdrawals. For example, in an exemplary embodiment:

$$\begin{matrix} - , 0 \to W 1 \\ - , W 1 \to W 2 \\ - , W 2 \to W 3 \\ … \\ - , W ( n - 1 ) \to W ( n ) ,\end{matrix}$$

where “W” is a withdrawal transaction.

In block 720, the remote system 160 determines whether a gap exists between adjacent withdrawal transactions.

If a gap exists between adjacent transactions, the remote system 160 determines whether transaction records are missing and a synchronization is needed, in block 730. For example, the following sum of withdrawal records indicate a missing transaction:
−,0→4
−,4→12
−,19→21 (missing transaction between 12 and 19).

Thus, the remote system 160 has information indicating the current sum of withdrawals for the smart cart 110 (which sum is 21), even though the remote system 160 does not have a transaction record (−,12→19) corresponding to the withdrawal of 7 from the smart card 110. This missing record scenario is indicative of an offline transaction (−,12→19) occurring between two online transactions (−,4→12 and −,19→21). Alternatively, one or both of the transactions bounding the missing transaction could have occurred offline and have since been communicated to the remote system 160 when the corresponding contactless device 120 obtained network 140 access to the remote system 160. Additionally, because the sum of withdrawals maintained on the card is current, even after an offline transaction, the balance of the card can be determined at the point of sale for the next merchant.

Synchronization will occur when the transaction record for the missing transaction is communicated to the remote system 160, which occurs when the corresponding contactless device 120 obtains network 140 access to the remote system 160. Then, the remote system 160 can analyze the transaction history to determine that all transaction records are included.

The sum of deposits could be analyzed in a similar manner if a deposit transaction is allowed to be performed offline.

From block 730, the method 270 proceeds to block 750.

Referring back to block 720, if a gap does not exist in adjacent transactions, the remote system 160 determines all records are present in block 740. From block 740, the method 270 proceeds to block 750.

In block 750, the remote system 160 determines whether overlapping transactions exist in the transaction history for the smart card 110.

If overlapping transactions exist, the remote system 160 determines an error has occurred (for example, a withdrawal occurred without writing a record to the smart card 110), in block 760. For example, the following illustrates an overlapping transaction:
−,0→4
−,4→12
−,4→8 (overlapping transaction as two transactions begin with a sum of withdrawals of −4).

If an overlapping transaction exists, the method 270 proceeds to block 760 in which the remote system 160 reports an error in the transaction history for the smart card 110 and deactivates the smart card 110 from further use.

Referring back to block 750, if overlapping transactions do not exist, the method 270 proceeds to block 770. In block 770, the remote system 160 determines errors do not exist.

From blocks 760 or 770, the method 270 proceeds to block 280 of FIG. 2 or block 575 of FIG. 5, as appropriate.

In an exemplary embodiment, the remote system 160 maintains a list of blocked (deactivated) smart cards 110. The device reader 150 and contactless device 120 receive a list of blocked smart cards 110 when connected to the remote system 160. Transaction requests from a blocked smart card 110 are rejected.

In an exemplary embodiment, a server key is utilized to authenticate data generated by the remote system 150. For example, the server key may be an asymmetric key, wherein a private key is known by the remote system 160 and a public key is known by the contactless device 120. In an exemplary embodiment, a separate private key is assigned to each merchant's contactless device 120. The key may be stored on a separate NFC-enabled card or stored on the remote system 160 and downloaded by the contactless device 120 upon merchant log-in.

In an exemplary embodiment, each deposit transaction is signed by the server key and each withdrawal transaction is signed by a contactless device 120 key. Whenever a merchant reads a smart card 110, it may verify that the transaction records stored on the card are signed by a valid server/contactless device 120 key.

In an alternative exemplary embodiment, a symmetric key may be utilized to encrypt the data on the smart card 110, so that an NFC-enabled device without such a key cannot comprehend the data on the smart card 110. The key is shared with the remote system 160, the contactless device 120, and the card reader 150.

### General

The exemplary methods and blocks described in the embodiments presented previously are illustrative, and, in alternative embodiments, certain blocks can be performed in a different order, in parallel with one another, omitted entirely, and/or combined between different exemplary methods, and/or certain additional blocks can be performed, without departing from the scope and spirit of the invention. Accordingly, such alternative embodiments are included in the invention described herein.

The invention can be used with computer hardware and software that perform the methods and processing functions described above. As will be appreciated by those having ordinary skill in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

Although specific embodiments of the invention have been described above in detail, the description is merely for purposes of illustration. Various modifications of, and equivalent blocks corresponding to, the disclosed aspects of the exemplary embodiments, in addition to those described above, can be made by those having ordinary skill in the art without departing from the spirit and scope of the invention defined in the following claims, the scope of which is to be accorded the broadest interpretation so as to encompass such modifications and equivalent structures.

What is claimed is:

1. A computer-implemented method for providing offline processing of purchases, comprising:
detecting, by a mobile communication device, a smart card device by a mobile communication device;
establishing, by the mobile communication device, a communication channel with the smart card device;
receiving, by the mobile communication device, a transaction history from the smart card device, the transaction history comprising information identifying a current sum of deposits and a current sum of withdrawals for an account associated with the smart card device;
reading, by the mobile communication device, the current sum of deposits and the current sum of withdrawals from the transaction history;
calculating, by the mobile communication device, a current smart card device balance by subtracting the current sum of withdrawals from the current sum of deposits;
determining, by the mobile communication device, whether the current balance is greater than or equal to a current transaction cost;
processing, by the mobile communication device, a debit transaction to debit the current transaction cost from the smart card device;
calculating, by the mobile communication device, a new sum of withdrawals by adding the current transaction cost to the current sum of withdrawals;
transmitting, by the mobile communication device, a transaction record to the smart card device, the transaction record indicating the transaction cost debited from the smart card device and the new sum of withdrawals; and
transmitting, by the mobile communication device, the transaction history and the transaction record to a remote computer management system that manages an account associated with the smart card device.

2. The computer-implemented method of claim 1, wherein the step of transmitting, by the mobile communication device, the transaction history and the transaction record to the remote computer management system is performed in real-time with the debit transaction.

3. The computer-implemented method of claim 1, further comprising:
storing, by the mobile communication device, the transaction history and the transaction record; and
establishing, by the mobile communication device, a network connection with the remote computer management system after completing the debit transaction with the smart card device,
wherein the debit transaction is performed offline without the network connection to the remote computer management system, and
wherein the step of transmitting the transaction history and the transaction record to the remote computer management system is performed after establishing the network connection with the remote computer management system.

4. The computer-implemented method of claim 1, wherein reading the current sum of deposits comprises:
reading the transaction history;
sorting deposit transactions in order of deposit from a previous deposit D(n−1) to a latest deposit D(n); and
reviewing the latest deposit transaction to identify the current sum of deposits.

5. The computer-implemented method of claim 1, wherein reading the current sum of withdrawals comprises:
reading the transaction history;
sorting withdrawal transactions in order of withdrawal from a previous withdrawal W(n−1) to a latest withdrawal W(n); and
reviewing the latest withdrawal transaction to identify the current sum of withdrawals.

6. The computer-implemented method of claim 1, wherein the debit transaction occurs offline.

7. The computer-implemented method of claim 1, wherein the communication channel is established using a near field communication (NFC) protocol.

8. The computer-implemented method of claim 1, wherein the mobile communication device is a mobile telephone.

9. The computer-implemented method of claim 1, wherein the mobile communication device comprises a stand-alone card reader.

10. A computer program product, comprising:
a non-transitory computer-readable medium having computer-readable program code embodied therein for providing offline processing of purchases, the computer-readable medium comprising:
computer-readable program code for establishing a communication channel with a smart card device;
computer-readable program code for receiving a transaction history from the smart card device, the transaction history comprising information identifying a current sum of deposits and a current sum of withdrawals for an account associated with the smart card device;
computer-readable program code for calculating a current smart card device balance by subtracting the current sum of withdrawals from the current sum of deposits;
computer-readable program code for determining whether the current balance is greater than or equal to a current transaction cost;
computer-readable program code for processing a debit transaction to debit the current transaction cost from the smart card device;
computer-readable program code for calculating a new sum of withdrawals by adding the current transaction cost to the current sum of withdrawals; and
computer-readable program code for transmitting a transaction record to the smart card device, the transaction record indicating the transaction cost debited from the smart card device and the new sum of withdrawals.

11. The computer program product of claim 10, further comprising computer-readable program code for transmitting, by the mobile communication device, the transaction history and the transaction record to a remote computer management system that manages an account associated with the smart card device.

12. The computer program product of claim 10, further comprising:
computer-readable program code for storing the transaction history and the transaction record; and
computer-readable program code for establishing a network connection with the remote computer management system after completing the debit transaction with the smart card device,
wherein the debit transaction is performed offline without the network connection to the remote computer management system, and
wherein transmitting the transaction history and the transaction record to the remote computer management system is performed after establishing the network connection with the remote computer management system.

13. The computer program product of claim 10, wherein the debit transaction occurs offline.

14. The computer program product of claim 10, wherein the communication channel is established using a near field communication (NFC) protocol.

15. The computer program product of claim 10, wherein the non-transitory computer-readable medium is implemented in a mobile communication device.

16. The computer program product of claim 15, wherein the mobile communication device is a mobile telephone.

17. The computer program product of claim 10, wherein the mobile communication device comprises a stand-alone card reader.

18. A computer-implemented method for providing offline processing of purchases, comprising:
receiving, by a smart card device, a request to establish a communication channel with a mobile communication device, the smart card device having stored thereon a transaction history comprising information identifying a current sum of deposits and a current sum of withdrawals for an account associated with the smart card device;
establishing, by the smart card device, the communication channel with the mobile communication device;
transmitting, by the smart card device, the transaction history to the mobile communication device;
requesting, by the smart card device, a debit transaction with the mobile communication device, the debit transaction for a transaction amount;
receiving, by the smart card device, a transaction record from the mobile communication device, the transaction record comprising information identifying the transaction amount and a new sum of withdrawals equal to the current sum of withdrawals plus the transaction amount; and
storing, by the smart card device, the transaction record.

19. The computer-implemented method of claim 18, further comprising terminating the communication channel with the mobile communication device.

20. The computer-implemented method of claim 18, wherein the communication channel is established using a near field communication (NFC).

21. The computer-implemented method of claim 18, wherein the mobile communication device is a mobile telephone.

22. A smart card, comprising:
a non-transitory computer-readable medium having computer-readable program code embodied therein for providing offline processing of purchases, the computer-readable medium comprising:
computer-readable program code for storing a transaction history comprising information identifying a current sum of deposits and a current sum of withdrawals for an account associated with the smart card;
computer-readable program code for establishing a communication channel with a payment processing device;
computer-readable program code for transmitting the transaction history to the payment processing device;
computer-readable program code for implementing a debit transaction with the payment processing device, the debit transaction for a transaction amount;
computer-readable program code for receiving a transaction record from the payment processing device, the transaction record comprising information identifying the transaction amount and a new sum of withdrawals equal to the current sum of withdrawals plus the transaction amount; and
computer-readable program code for storing the transaction record.

23. The smart card of claim 22, further comprising computer-readable program code for terminating the secure communication channel with the payment processing device.

24. The smart card of claim 22, wherein the payment processing device is a mobile communication device.

25. The smart card of claim 22, wherein the payment processing device is a mobile telephone.
